(19) United States
(12) Patent Application Publication
(10) Pub. No.: US 2006/0233484 A1
(43) Pub. Date: Oct. 19, 2006

(54) Adhesive-assembled fiber-optic interferometer

(76) Inventors: Richard Van Neste, Quebec (CA); Claude Belleville, L'Ancienne-Lorette (CA); Ninon Belleville, Charlesbourg (CA); Sylvain Bussiere, Val-Belair (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/387,831

(22) Filed: Mar. 24, 2006

Related U.S. Application Data
(60) Provisional application No. 60/664,648, filed on Mar. 24, 2005.

(51) Int. Cl. G02B 6/00

(52) U.S. Cl. 385/12

(57) ABSTRACT

A method to assemble optical fiber devices and a fiber optic sensor is provided. It features a small adhesive joint between the fiber and a capillary tube by means of a small recess carved on the side of the fiber. This recess acts as a reservoir for the adhesive during the insertion of the fiber inside the tube. Then, the tube is heated so that the adhesive swells out of the recess to make the joint between the tube and the fiber. This method is used to assemble a fiber optic Fabry-Perot interferometer. This interferometer can be used as a sensor for the measurement of a number of physical parameters.

### CROSS-REFERENCE TO RELATED APPLICATIONS

This application claims priority under 35USC§119(e) of U.S. provisional patent application 60/664,648, filed Mar. 24, 2005, the specification of which is hereby incorporated by reference.

### FIELD OF THE INVENTION

The present invention generally relates to the field fiber-optic devices, and more specifically to fiber optic sensors wherein a fiber-optic interferometer is used for measuring a physical parameter such as a pressure, temperature, etc., and especially strain of a deformed body. The methods introduced by this invention can also be used in other fields such as optical telecommunication devices and optical instrumentation.

### BACKGROUND OF THE ART

Strain sensors using fiber-optic Fabry-Perot interferometers (FFPI) are now of common use where a harsh environment or high electric field or noise prevents the use of conventional foil electric strain gages. FFPI can also be made very small, thus enabling its use in locations unreachable by foil gages.

A Fabry-Perot cavity is formed when two partially reflective mirrors are placed parallel in front of each other. The light incident to the cavity is reflected or transmitted in a way that is dependent on the wavelength of the incident light and the distance that separates the two mirrors. Such a Fabry-Perot cavity can be made with fiber optics and, when solidly attached to a deformed body, will provide a light signal which has been modulated accordingly to the strain in the body.

A number of ways to construct a FFPI have been proposed in the past. For example, one can write two Bragg gratings inside an optical fiber, as described in Belsley, K. L., Carroll, J. B., Hess, L. A., Huber, D. R., Schmadel, D., “Optically multiplexed interferometric fiber optic sensor system”, Proceedings of the SPIE—The International Society for Optical Engineering, vol. 566, pp. 257-65 (1985). The principal advantage of this technique is that the fiber is not damaged during the fabrication process. This type of sensor can thus survive to as much strain as a pristine fiber. This construction has two drawbacks. First, the sensitivity of the sensor is strictly determined by the Fabry-Perot cavity length. Second, since the light is guided by the optical fiber between the mirrors, transverse strain can affect the reading by inducing birefringence and refractive index changes.

Another arrangement proposed in C. E. Lee, R. A. Atkins, and H. F. Taylor, “Performance of a fiber-optic temperature sensor from minus 200 to 1050 degree C.,” Opt. Lett. vol. 13, pp. 1038-1041 (1988), uses dielectric mirrors coatings on end faces of fibers which are fusion-spliced on a continuous length of fiber. This configuration has the same drawbacks as the Bragg mirrors added to the fact that the fusion splices, because of the presence of the mirrors, compromise the fiber integrity, which can lead to fiber breakage when the sensor is exposed to high strains.

In J. S. Sirkis et al., “In-line fiber etalon for strain measurement,” Opt. Lett. vol. 18, pp. 1973-1976 (1993), Sirkis and Brennan have proposed splicing two cleaved fibers to a short length of hollow-core fiber. The Fabry-Perot cavity is defined by the length of the hollow-core fiber. This arrangement is called the in-line fiber \overline{e}talon (ILFE). It eliminates the transverse strain problems encountered on the two previous configurations but it retains the disadvantage of having the sensor sensitivity strictly defined by the cavity length. Another, even simpler arrangement is proposed in Christopher J. Tuck et al., “New techniques for manufacturing optical fibre-based fibre Fabry-Perot sensors”, Proceedings of SPIE—The International Society for Optical Engineering, vol. 4694, pp. 43-52 (2002) where a small area on two optical fiber end faces are etched as to form a Fabry-Perot cavity when the two fibers are spliced.

Finally, in K. A. Murphy et al. “Quadrature phase-shifted, extrinsic Fabry—Perot optical fiber sensors,” Opt. Lett. vol. 16, p. 273-275 (1991), it is proposed the use of a glass microcapillary into which two fibers with flat, perpendicular, end faces are inserted. The capillary's inside diameter closely matches the diameter of the fibers in order to secure a precise parallelism of the mirrors. Its outer surface is usually coated with a thin layer of polyimide to protect it from scratches that would eventually lead to breakage of the sensor during its use. The fibers are then attached to the ends of the capillary with adhesive.

Such a design, called the extrinsic Fabry-Perot interferometer (EFPI), has all the advantages of the ILFE with the added benefit of being able to adjust the strain sensitivity of the sensor by choosing the appropriate capillary length and still being able to choose the Fabry-Perot cavity length independently. Using adhesive to fix the fibers also has the advantage of compromising neither the capillary nor the fiber integrity.

However, it is very difficult, if not impossible, to properly control the adhesive ingression into the capillary. Hence, the sensitivity factor of the sensor is hard to determine because of the non-uniform glue line inside the capillary. This can also lead to non-linearity in the sensor response: because the adhesive is a relatively soft material, the effective position of the glue line is moving as stress is applied to the sensor. Finally, the dimensional discontinuity at both ends of the capillary induces some edge effects.

To avoid the end-effect problem, it is desirable to have the fixing joints between the fibers and the capillary away from both ends of the capillary. Also, it is better to have a well localized joint, with an area as small as possible to minimize non-linearities in the sensor response. In C. Belleville and G. Duplain, “White-light interferometric multimode fiber-optic strain sensor,” Opt. Lett., vol. 18, 78-81 (1993), Belleville and Duplain suggest to weld the fibers in the capillary. A CO2 laser or an arc-fusion fiber-optic splicer can be used for this. Small, very stiff, well controlled joints can be obtained in this manner. However, this is done at the cost of added fragility since the protective polyimide buffer of the capillary is burned over the solder points and also because of the residual stress induced by the welding process.

### SUMMARY

It is thus desirable to combine the sturdiness of adhesive-bonded sensors with the high response linearity offered by the weld-bonded sensors. For this, one needs to have each fiber bonded to the capillary by a small dot of adhesive, away from the edge of the capillary. Up to now, it has not been feasible to do this in a systematic, reproducible manner.

The present invention provides means to bond the fiber inside a capillary with a small dot of adhesive away from the edge of the capillary in a systematic, reproducible manner.

The invention provides a recess on the side of the fiber. The recess acts as a container or reservoir for the adhesive. At room temperature, the hardened or partially cured adhesive is solid. Hence, the recess makes room for the adhesive bead to enter the capillary along with the fiber. Once inside the capillary, heating the assembly will make the adhesive to become liquid, expand and swell out of the recess. If one can heat and cool rapidly on demand, the amount of adhesive swelling can be accurately controlled. Once a suitable bond area has been attained, it is possible, if necessary, to slowly complete the curing of the adhesive by an automatic temperature-controlled oven without inducing further swelling of the adhesive.

One aspect of the invention provides an optical fiber device comprising: a tube having an inside diameter; a first optical fiber for inserting in said tube and having an outside diameter closely matching said inside diameter and a first recess on its outside surface, said first recess for carrying an adhesive material inside said tube; and said adhesive material for forming a first adhesive joint between said optical fiber and said tube, a location of said adhesive joint along said optical fiber being defined by a location of said recess.

Another aspect of the invention provides an optical fiber interferometer sensing device for measuring a physical quantity and having a sensitivity comprising: a tube having a longitudinal strain to be sensitive to said physical quantity, said tube having an inside diameter; a first optical fiber for inserting in said tube and having an outside diameter closely matching said inside diameter, a first reflective surface on an end inside said tube and a recess on its outside surface, said recess for carrying an adhesive material inside said tube; said adhesive material for forming a first adhesive joint between said optical fiber and said tube, a location of said adhesive joint along said optical fiber being defined by a location of said recess and at least partly defining said sensitivity; and a second reflective surface mechanically connected to said tube, said first and said second reflective surfaces defining an interferometer cavity, a length of said interferometer cavity varying with said physical quantity as a result of said longitudinal strain.

Another aspect of the invention provides a method for bonding an optical fiber in a tube comprising: providing a recess on an outside surface of said optical fiber; depositing an adhesive in said recess; inserting said optical fiber in said tube, an inside diameter of said tube closely matching an outside diameter of said fiber and said adhesive being highly viscous to solid; and heating said adhesive and an area of said optical fiber and an area of said tube adjacent to said adhesive in order that said adhesive swells out of said recess and creates a bond between said optical fiber and said tube.

Another aspect of the invention provides an optical fiber interferometer for measuring a physical quantity, the optical fiber interferometer comprising a tube and two optical fibers, inserted in the tube and forming an interferometric cavity, each of the two optical fibers having an outside diameter that closely matches an inner diameter of the tube, and each of the two optical fibers having, at their periphery, a recess comprising an adhesive material, a quantity of the adhesive material being in contact with the fiber and another quantity of the adhesive material being in contact with the inner diameter of the tube, whereby the fiber is attached to the tube, wherein one of the optical fibers is for coupling light to the interferometric cavity.

A method to assemble optical fiber devices and a fiber optic sensor is provided. It features a small adhesive joint between the fiber and a capillary tube by means of a small recess carved on the side of the fiber. This recess acts as a reservoir for the adhesive during the insertion of the fiber inside the tube. Then, the tube is heated so that the adhesive swells out of the recess to make the joint between the tube and the fiber. This method is used to assemble a fiber optic Fabry-Perot interferometer. This interferometer can be used as a sensor for the measurement of a number of physical parameters.

The present invention as well as its numerous advantages will be better understood by the following non-restrictive description of possible embodiments made in reference to the appended drawings.

### DESCRIPTION OF THE DRAWINGS

Further features and advantages of the present invention will become apparent from the following detailed description, taken in combination with the appended drawings, in which:

FIG. 1 is a schematic side elevation view of an optical fiber, in accordance with a first embodiment of the present invention, in which a small recess has been sculpted at a periphery of the fiber;

FIG. 2 is a longitudinal cross-sectional view of a tube, in accordance with a first embodiment of the present invention, in which is inserted the optical fiber of FIG. 1 and showing the tube being heated;

FIG. 3 is a longitudinal cross-sectional view of the tube of FIG. 2, with the fiber bonded inside the tube.

FIG. 4 is a cross-sectional view taken along the lines 4-4 of FIG. 3, illustrating the bond joint between the tube and the fiber.

FIG. 5 is a longitudinal cross-sectional view of an interferometer, in accordance with a second embodiment of the present invention.

It will be noted that throughout the appended drawings, like features are identified by like reference numerals.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

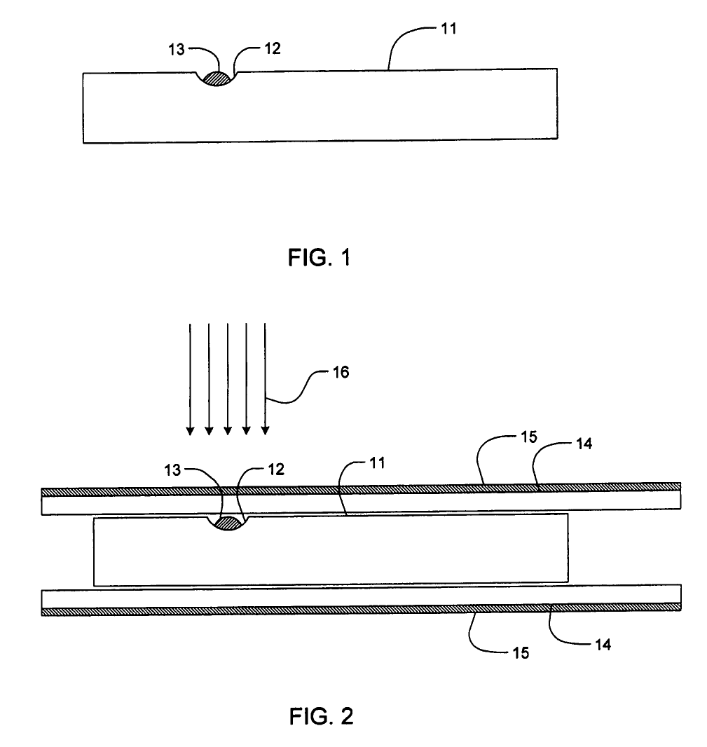

Referring to FIG. 1, a small recess 12, or a notch, has been carved on the side of an optical fiber 11. The fiber diameter is typically 125 μm. Hence the recess is very small: typically 30 μm deep and 50 μm wide. Many techniques can be used to make this recess: laser ablation, chemical etching and others. But one of the simplest ways is using a dicing saw with a thin diamond blade. If the blade has been properly worn out, the blade's edge forms a small radius. So when cutting in the direction perpendicular to the axis of the fiber, one can obtain a shallow cylindrical cut on the fiber surface. Good results have been obtained with a 55 mm diameter, 100 μm thick resin blade with 46 μm particle size turning at 18 000 RPM, but similar or better results could be obtained with a different blade.

A small bead of adhesive 13 is then deposited in the recess. Of course, one has to make sure that the bead size is smaller than the recess and also that no adhesive has been deposited outside the recess. Here again, different techniques can be used. For example, a small drop of fresh adhesive can be first deposited and thereafter, the adhesive partially cured. An alternative and preferred method uses a drop of partially cured epoxy on the tip of a very fine needle. One can simply put the drop in contact with the recess and heat the fiber so that the adhesive becomes liquid and wets the recess with the proper amount of material. The needle is then removed and the fiber is cooled down so that the adhesive bead becomes hard again. Also, a great number of adhesives can be used for this purpose. By way of non-limiting example, one such suitable adhesive is Aremco 526N two-part, high temperature epoxy. A partial cure of 15 minutes at 100° C. is sufficient to gel the epoxy but insufficient to fully cure it. Heating it at approximately 175° C. for short periods of time brings it to a liquid state and back to a gelled state when cooled down to room temperature. But this method is not restricted to epoxies other adhesives, like solder glass or thermo plastics can also be used. Among the factors in choosing the adhesive is that it is hard or highly viscous at room temperature, but able to flow at a higher temperature. Another desirable, feature is that it can be fully cured at an intermediate temperature so that further exposition to higher temperature will not put it back into liquid state.

The next step consists in inserting the fiber inside a micro-capillary 14. FIG. 2 shows the resulting assembly during heating and before swelling of the adhesive 13. Here, the micro-capillary 14 is shown with a protective polyimide coating 15 but this method will also work with an unprotected capillary. The capillary is preferably made of fused silica since it is the same material as the fiber. Other materials could be used. In one embodiment of the present invention, the capillary material coefficient of thermal expansion matches that of the fiber.

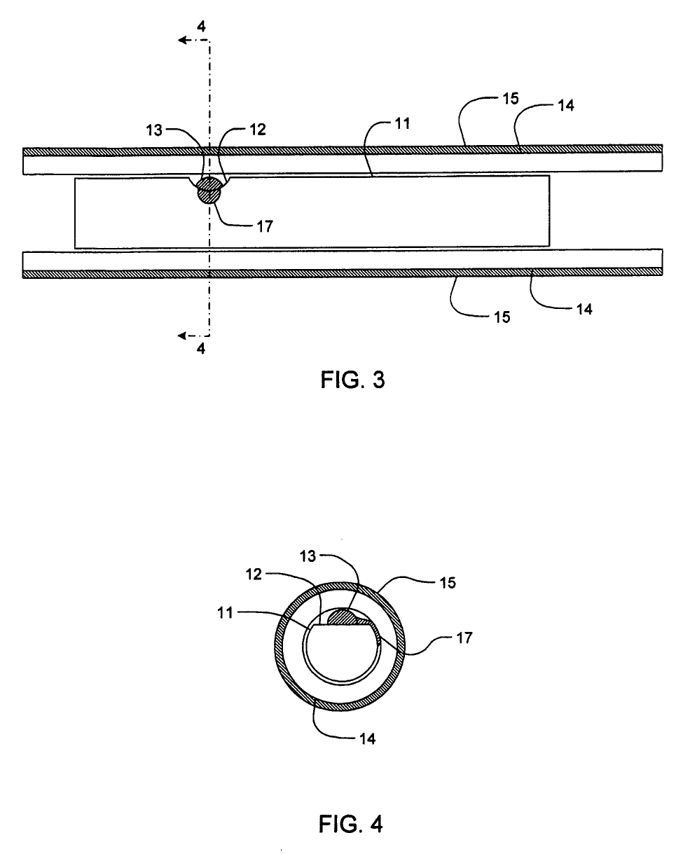

The focused beam 16 of a CO2 laser can be used to locally heat the capillary around the adhesive. In one embodiment of the invention, the laser power is very low, less than one watt, and the beam width is approximately 300 μm. This suffices to sufficiently heat by optical absorption the capillary to a temperature where it will heat by conduction the adhesive enough to bring it to a liquid state. At that point, the adhesive expands and immediately tacks the capillary inner wall. Just a few seconds of CO2 laser exposure is enough to obtain a small bonded area that is approximately 50 μm wide. This situation is illustrated in FIG. 3 where the bonded area 17 is shown. A cross-sectional view along the plane 4-4 defined in this figure is shown in FIG. 4. Here, it is seen how the adhesive has swollen out of the recess 12, between the capillary 14 inner wall and the fiber 11 round surface. Of course, other heat sources than the radiation of a laser could be used for the same purpose. For example, one could use heated air flow or a loop of electric current heated wire.

The last step is to completely cure the adhesive so that further heating will not bring the adhesive back to a liquid state. For the adhesive mentioned above, curing for four hours at 100° C., two hours at 150° C., two hours at 200° C., two hours at 250° C. and two hours at 325° C. sequentially gives satisfactory results. This is best accomplished in a computer-controlled oven so it can be done overnight. As mentioned earlier, this final step depends heavily on the adhesive used and, in some cases, could be altogether omitted if the heating in the step before has been sufficient to fully cure the adhesive or if the device is not expected to be stored or used at elevated temperatures. Furthermore, heat could not be needed if the adhesive used is a room temperature curable adhesive or a light-curable adhesive.

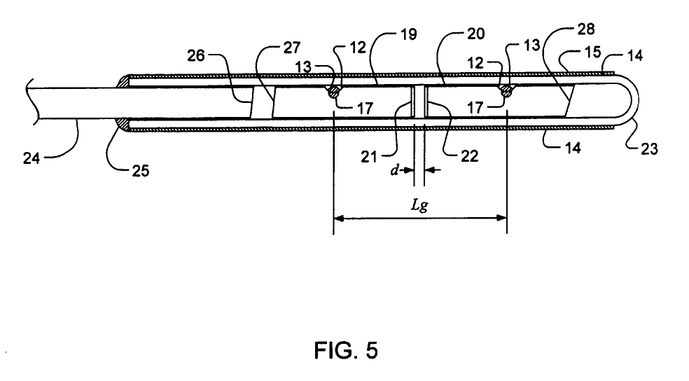

A fiber-optic Fabry-Perot strain or displacement sensor using the bonding method described hereinabove is schematically illustrated in FIG. 5. Two pieces of fiber, the incident fiber 19 and the reflection fiber 20, are fixed by adhesive bonds spots 17 inside a capillary 14 with the method described earlier. The facing fiber ends are cleaved or polished and coated with partially-reflecting mirrors 21 and 22. These two mirrors form a Fabry-Perot interferometer of which the cavity length is shown here as d. The distance between the two bonding areas 17 defines the gage length, Lg. When this sensor is used as a strain measuring device, it is either bonded on the surface or embedded inside a body from which one wishes to measure the deformation. As the body is stretched, the capillary 14 is also stretched with an equal strain. Hence, the distance between the two bonding points will change according to
Lg(ε)=Lg(0)·ε
where ε is the strain, Lg(ε) is the gage length for a given strain ε and Lg(0) is the gage length when no strain is applied. Since no strain is applied on the incident fiber 19 and the reflection fiber 20, the distance between their ends, and consequently the cavity length d, will change by the same amount:
d(ε)=Lg(0)·ε.

Hence, the initial gage length is representative of the sensitivity of the sensor: the longer is Lg(0), the more the cavity length d(ε) will change for a given strain ε.

Methods known in the art can be used by the signal conditioner to demodulate and extract the cavity length information from the optical signal of the sensor. Suffice it to say that light enters from the incident fiber 19 and is reflected by the Fabry-Perot cavity 21-22. Light in and out of the incident fiber is coupled from and to a third fiber, the input/output fiber 24, which is connected to the optical conditioner. The input/output fiber 24 is attached in the capillary by way of an adhesive 25, which can be different than the adhesive used in the beads 13. Another purpose of the adhesive 25 is that it seals this end of the capillary from liquids or liquid intrusion. In an embodiment, the opposite end of the capillary is sealed by a drop of adhesive or, as illustrated here 23, by melting the glass at this end with a CO2 laser or using an arc-fusion splicer. This way, the interferometer is completely sealed, which is advantageous if it is intended to be glued on or embedded in a body.

In an embodiment, a third fiber, the input/ouput fiber 24, is used instead of simply extending the incident fiber 19 all the way to the signal conditioner because it permits free movement of the fibers between the sealing adhesive 25 and the incident fiber 19 bonding point. Alternatively, a continuous length of fiber between these two points could be used. Strain applied to the capillary or to the input/output fiber 24 would then be transferred to the incident bonding point, a situation that could possibly result into non-linearities in the sensor response or eventually into breakage of the bonding point.

In an embodiment, the facing ends 26, 27 of the input/output fiber 24 and the incident fiber 19 are cleaved at an angle to minimise reflection losses. Similarly, the far edge 18 of the reflection fiber 20 is shattered or cleaved at an angle to prevent reflected light to pass a second time through the Fabry-Perot cavity. Another way to achieve the latter result is to use a reflection fiber 20 that is either non-guiding, or that has a significantly different core than the other fibers 19 and 24.

One should understand that the reflection fiber 20 does not have to be an optical fiber at all since no useful light is recovered from this second fiber. For instance, one could use a high thermal expansion glass fiber or even a metallic fiber instead of an optical fiber. This could be useful for example as a strain sensing device that would have its thermal response adjusted so as to counteract the expansion of the material to which the sensor is attached to.

Furthermore, in particular optical devices, the reflection fiber 20 could be replaced by a reflective surface attached to one end of the tube 14 and facing the partially-reflecting mirror 21 to provide the Fabry-Perot cavity. Only one fiber bonding would than be used (to bond the incident fiber 19 to the tube 14) and the distance between this bonding area 17 and the far end reflective surface would define the gage length, Lg. The reflective surface could be attached to the end of the tube 14 using an adhesive or any other bonding method known in the art.

The core size of the incident fiber 19 and the input/ouput fiber 24 and the reflectivity of the mirrors 21 and 22 depends largely on the light source and signal conditioner used. In one embodiment, a 50 μm core fiber with 0.22 numerical aperture and 30% reflectivity mirrors are used along with a filament white light bulb light source and a white-light interferometry signal conditioner. But this is not the only possible configuration. For example, acceptable results could also be obtained using single-mode fibers with a LED source and an optical spectrum analyzer.

The method presented here is not restricted to strain measurement but can also be applied to other fiber-optic sensing devices such as for temperature or pressure measurement. Also, this method as well as the Fabry-Perot interferometer presented here can be used in other fields such as optical telecommunications and for other optical devices such as fiber-optic filters or modulators where it would be desirable to have a fiber assembled inside a microcapillary.

While this invention has been described in terms of specific embodiments with some variations in their construction, those skilled in the art will recognize that the invention can be practiced in other embodiments that are within the spirit and scope of the invention. The scope of the invention is therefore intended to be limited solely by the scope of the appended claims.

1. An optical fiber device comprising:
a tube having an inside diameter;
a first optical fiber for inserting in said tube and having an outside diameter closely matching said inside diameter and a first recess on its outside surface, said first recess for carrying an adhesive material inside said tube; and
said adhesive material for forming a first adhesive joint between said optical fiber and said tube, a location of said adhesive joint along said optical fiber being defined by a location of said recess.

2. The optical fiber device as claimed in claim 1, wherein said first optical fiber comprises an end located inside said tube, said end comprising a first reflective surface.

3. The optical fiber device as claimed in claim 2, further comprising a second reflective surface, said first and said second reflective surfaces defining an interferometer cavity.

4. The optical fiber device as claimed in claim 3, further comprising a second optical fiber inserted in said tube and having an outside diameter closely matching said inside diameter, said second optical fiber comprising an end for inserting inside said tube, said second optical fiber end having said second reflective surface thereon and a second recess on its outside surface for carrying adhesive material, said adhesive material for forming a second adhesive joint between said second optical fiber and said tube.

5. The optical fiber device as claimed in claim 3, wherein said second reflective surface is attached to said tube.

6. The optical fiber device as claimed in claim 3, further comprising a thermally sensitive material inserted in said tube and having an end inside said tube with said second reflective surface thereon, and further comprising a second joint for attaching said sensitive material to said tube.

7. The optical fiber device as claimed in claim 5, wherein said thermally sensitive material comprises at least one of a second optical fiber, a high thermal expansion glass fiber and a metallic fiber.

8. The optical fiber device as claimed in claim 3, wherein said optical fiber interferometer cavity is a Fabry-Perot interferometer.

9. The optical fiber device as claimed in claim 1, wherein said first adhesive joint comprises one of a two-part adhesive, a room temperature curable adhesive, a solder-glass adhesive, a light-curable adhesive and a meltable thermoplastic adhesive.

10. The optical fiber device as claimed in claim 1, wherein said recess is carved using at least one of diamond sawing, laser ablation and chemical etching.

11. An optical fiber interferometer sensing device for measuring a physical quantity and having a sensitivity comprising:
a tube having a longitudinal strain to be sensitive to said physical quantity, said tube having an inside diameter;
a first optical fiber for inserting in said tube and having an outside diameter closely matching said inside diameter, a first reflective surface on an end inside said tube and a recess on its outside surface, said recess for carrying an adhesive material inside said tube;
said adhesive material for forming a first adhesive joint between said optical fiber and said tube, a location of said adhesive joint along said optical fiber being defined by a location of said recess and at least partly defining said sensitivity; and
a second reflective surface mechanically connected to said tube, said first and said second reflective surfaces defining an interferometer cavity, a length of said interferometer cavity varying with said physical quantity as a result of said longitudinal strain.

12. The optical fiber interferometer sensing device as claimed in claim 11, further comprising a second optical fiber for inserting in said tube and having an outside diameter closely matching said inside diameter, said second optical fiber comprising an end for inserting inside said tube with said second reflective surface thereon and a recess on its outside surface, and said optical fiber interferometer sensing device further comprising a second adhesive joint between said second optical fiber and said tube, said second reflective surface for connecting to said tube using said second optical fiber.

13. The optical fiber interferometer sensing device as claimed in claim 12, further comprising a coupling optical fiber optically coupled to said first optical fiber, protruding from and attached to said tube and mechanically unconnected to said first optical fiber whereby a longitudinal strain in said tube does not induce stress in said first and said coupling optical fibers.

14. The optical fiber interferometer sensing device as claimed in claim 11, further comprising a thermally sensitive material inserted in said tube and having an end inside said tube with said second reflective surface thereon, and further comprising a second joint attaching said sensitive material to said tube, said second reflective surface being connected to said tube through said second sensitive material.

15. The optical fiber interferometer sensing device as claimed in claim 14, wherein said thermally sensitive material comprises at least one of a second optical fiber, a high thermal expansion glass fiber and a metallic fiber.

16. The optical fiber interferometer sensing device as claimed in claim 11, wherein said optical fiber interferometer is a Fabry-Perot interferometer.

17. The optical fiber interferometer sensing device as claimed in claim 11, wherein said optical fiber interferometer sensing device comprises a strain sensing device.

18. The optical fiber interferometer sensing device as claimed in claim 11, wherein said first and said second reflective surfaces are facing each other and are parallel.

19. The optical fiber interferometer sensing device as claimed in claim 11, wherein said first reflective surface comprises one of a partly reflecting dielectric coating and a metallic coating.

20. The optical fiber interferometer sensing device as claimed in claim 11, wherein said first adhesive joint comprises one of a two-part adhesive, a room temperature curable adhesive, a solder-glass adhesive, a light-curable adhesive and a meltable thermoplastic adhesive.

21. The optical fiber interferometer sensing device as claimed in claim 11, wherein said first optical fiber protrudes from said tube.

22. The optical fiber interferometer sensing device as claimed in claim 11, wherein said recess is carved using one of diamond sawing, laser ablation and chemical etching.

23. A method for bonding an optical fiber in a tube comprising:
providing a recess on an outside surface of said optical fiber;
depositing an adhesive in said recess;
inserting said optical fiber in said tube, an inside diameter of said tube closely matching an outside diameter of said fiber and said adhesive being highly viscous to solid; and
heating said adhesive and an area of said optical fiber and an area of said tube adjacent to said adhesive in order that said adhesive swells out of said recess and creates a bond between said optical fiber and said tube.

24. The method as claimed in claim 23, wherein said optical fiber comprises a first reflective surface on an end inside said tube.

25. The method as claimed in claim 24, further comprising:
providing a second recess on an outside surface of a second optical fiber;
depositing a second adhesive in said second recess;
inserting said second optical fiber in said tube, an outside diameter of said second-optical fiber closely matching said inside diameter of said tube and said adhesive being highly viscous to solid; and
heating said second adhesive and an area of said second optical fiber and an area of said tube adjacent to said adhesive in order that said adhesive swells out of said adhesive recess and creates a bond between said adhesive optical fiber and said tube.

26. The method as claimed in claim 25, wherein said second optical fiber comprises a second reflective surface on an end inside said tube and facing said first surface, said first and said second reflective surfaces defining an interferometer cavity.

27. The method as claimed in claim 23, further comprising curing said adhesive such that its physical properties are substantially fixed for long term use over a suitable range of temperatures.

28. The method as claimed in claim 27, wherein said curing comprises heating said adhesive using at least one of a stepwise and a ramping heating process in such a way that further heating no longer brings the adhesive to a liquid state.

29. The method as claimed in claim 23, further comprising hardening said adhesive before said inserting.

30. The method as claimed in claim 23, wherein said heating comprises the use of at least one of laser radiation, hot gas flow and electric filament.

31. The method as claimed in claim 23, wherein said heating uses a CO2 laser.

32. The method as claimed in claim 27, wherein said adhesive is a light-curable adhesive and said curing comprises exposing said adhesive to at least one of light and ultraviolet radiation in such a way that further heating no longer brings said adhesive to a liquid state.

33. The method as claimed in claim 23, wherein said adhesive comprises one of a two-part adhesive, a room temperature curable adhesive and a solder-glass adhesive.

34. The method as claimed in claim 23, wherein said providing comprises carving said recess using at least one of diamond sawing, laser ablation and chemical etching.

35. An optical fiber interferometer for measuring a physical quantity, the optical fiber interferometer comprising a tube and two optical fibers, inserted in the tube and forming an interferometric cavity, each of the two optical fibers having an outside diameter that closely matches an inner diameter of the tube, and each of the two optical fibers having, at their periphery, a recess comprising an adhesive material, a quantity of the adhesive material being in contact with the fiber and another quantity of the adhesive material being in contact with the inner diameter of the tube, whereby the fiber is attached to the tube, wherein one of the optical fibers is for coupling light to the interferometric cavity.
